(19) United States
(12) Patent Application Publication
(10) Pub. No.: US 2009/0106703 A1
(43) Pub. Date: Apr. 23, 2009

(54) METHOD AND APPARATUS TO PROVIDE USER-CUSTOMIZED CONTENT

(75) Inventors: Hong-seok Park, Ansan-si (KR); Jin-seok Choi, Yongin-si (KR); Seong-hun Jeong, Yeongtong-gu (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/185,899

(22) Filed: Aug. 5, 2008

(30) Foreign Application Priority Data
Oct. 18, 2007 (KR) 2007-105037

(51) Int. Cl. G06F 3/048; G06F 17/30; G06F 7/06

(52) U.S. Cl. 715/846; 707/4; 707/E17.014

(57) ABSTRACT

Provided are method and apparatus to provide user-customized content using mark log information of a user to provide content that are customized according to a user. The method includes display selected content, generating mark log information of a user according to markings of the displayed content, searching content related to the mark log information on a server and linking the content found via the searching to the mark log information.

### CROSS-REFERENCE TO RELATED APPLICATIONS

This application claims priority under 35 U.S.C. §119(a) from Korean Patent Application No. 10-2007-0105037, filed on Oct. 18, 2007 in the Korean Intellectual Property Office, the disclosure of which is incorporated herein in its entirety by reference.

### BACKGROUND OF THE INVENTION

1. Field of the Invention

The present general inventive concept relates to a content display device, and, more particularly, to a method and apparatus to provide user-customized content using mark log information of a user.

2. Description of the Related Art

In general, examples of conventional content-providing devices are mobile terminals, e-books, TVs, etc. Such content-providing devices are connected to a network to download content, requested by a user, from a web server.

A terminal for e-books displays content through a browser while the terminal is on-line or off-line, and such content is displayed in a similar form as a paperback book.

Thus, the terminal for e-books provides moving images to the user for educational purposes, where learned content can be tested, and the main points of the learned content can be summarized.

A TV receives broadcasting signals in a wired/wireless manner or gets required content by downloading the content via a network. Also, the TV transmits/receives content to/from a mobile terminal, such as a remote control, in a wired/wireless manner.

In such a content-providing device, content received from a broadcasting station or stored in a memory of the content providing device are linked to a large amount of documents such as moving images, dictionaries, and images, which can be referred to as study-aid content.

However, the user has to select and link the large amount of content one by one.

Accordingly, time is wasted since the user has to select and link the large amount of content provided in the conventional content-providing device.

### SUMMARY OF THE INVENTION

The present general inventive concept provides a method of providing user-customized content such that the user-customized content is automatically searched for by using mark log information to provide user-customized content, and the user-customized content can also be automatically searched for off-line by using mark log information.

The present general inventive concept also provides a user-customized content providing apparatus to which the method of providing user-customized content is applied.

Additional aspects and utilities of the present general inventive concept will be set forth in part in the description which follows and, in part, will be obvious from the description, or may be learned by practice of the general inventive concept.

The foregoing and/or other aspects of the present general inventive concept may be achieved by providing a method of providing digital content, including displaying selected content, generating mark log information according to marking of the displayed content, and searching for content related to the generated mark log information on a server and linking the content found via the searching to the mark log information.

The foregoing and/or other aspects of the present general inventive concept may also be achieved by providing a method of providing user-customized content, the method including selecting content, determining whether mark log information in a predetermined format exists, if it is determined that mark log information in the predetermined format exists, loading the mark log information, displaying a notification message notifying a user of the selected content and content linked to the loaded mark log information, generating mark log information regarding the displayed content according to markings in a predetermined format, and searching content according to the mark log information and downloading the content.

The foregoing and/or other aspects of the present general inventive concept may be achieved by providing an apparatus to provide content, including a storing unit to store content and mark log information of a user, a display unit to display text-based content, and a control unit generating mark log information according to user marking of the content displayed in the display unit and storing the mark log information to the storing unit, and searching for content related to the mark log information in a web server and, once the content is found in the web server, the control unit to download the content from the web server to link the content to the mark log information.

The foregoing and/or other aspects of the present general inventive concept may be achieved by providing a method of providing user-customized digital content, the method including receiving a command to search for digitally stored content, display content retrieved from the search, receiving one or more marks to select content for the displayed content, generating a mark log from the received one or more marks to select content, and searching content on a storage device or remote server based at least in part on the generated mark log.

The method may further include providing content retrieved from the search based at least in part on the generated mark log.

The method may further include where the provided content is audio content, video content, audio-visual content, or text, or any combination thereof.

The method may further include classifying the received one or more marks based at least in part on one or more predetermined classifications, or user-defined classifications, or any combination thereof.

The method may further include providing content retrieved from the search based at least in part on the classified one or more marks.

### BRIEF DESCRIPTION OF THE DRAWINGS

The above and other features and utilities of the present general inventive concept will become more apparent by describing in detail exemplary embodiments thereof with reference to the attached drawings in which:

FIG. 1 illustrates a functional block diagram of a user-customized content providing apparatus according to an embodiment of the present general inventive concept;

FIG. 2 is a flowchart illustrating a method of providing user-customized content to an apparatus having a text viewer, according to an embodiment of the present general inventive concept;

FIG. 3 is a flowchart illustrating a method of providing user-customized content in an apparatus when the apparatus changes from off-line to on-line;

FIG. 4 illustrates mark log information by a user, according to an embodiment of the present general inventive concept;

FIG. 5 illustrates a conceptual diagram of providing content according to user mark log information, according to an embodiment of the present general inventive concept;

FIG. 6 illustrates a conceptual diagram of separating content and linking the content to mark log information;

FIG. 7 illustrates a user-customized content providing apparatus according to another embodiment of the present general inventive concept;

FIGS. 8A through 8C illustrate types of text-based meta information applied in FIG. 7; and

FIG. 9 is a flowchart illustrating a method of providing user-customized content realized in the apparatus of FIG. 7, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

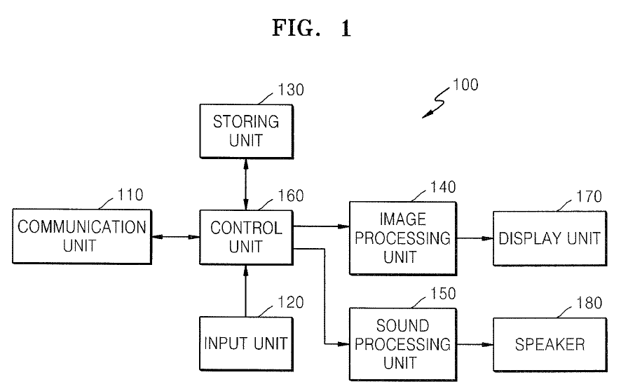

FIG. 1 illustrates a functional block diagram of a user-customized content providing apparatus 100 according to an embodiment of the present general inventive concept.

The user-customized content providing apparatus 100 includes a communication unit 110, an input unit 120, a storing unit 130, an image processing unit 140, a sound processing unit 150, a control unit 160, a display unit 170, and a speaker 180.

The communication unit 110 includes a communication interface and performs bi-directional communication with a web server or other suitable server (not illustrated) via a communications network in a wired and/or wireless manner. The communication unit 110 receives corresponding content information according to content request signals generated from the control unit 160 via a web server in a wired and/or wireless manner.

The web server (not illustrated) provides various A/V (audio/video) content according to content requests sent by the communication unit 110.

The input unit 120 receives a user command input via a key module having a plurality of keys, or a touch screen, or any other suitable user input device. For example, the input unit 120 may receive a content selection command from a user selecting predetermined keys of the input unit 120 that are set in advance, and the input unit 120 communicates the received content selection command to the control unit 160.

The storing unit 130 can be a flash memory, or an HDD (hard disk drive), or any other suitable digital storage medium, and stores a control program that, when executed, drives the control unit 160 to provide A/V content stored on the storing unit 130 in a predetermined file format and metadata to a user. For example, the A/V content provided to the user may be based at least in part on a received selection of content made by the user with the input unit 120.

The control unit 160 outputs the content selection received from the input unit 120 to the image processing unit 140, generates log information on the content to be displayed according to user marking, searches for content related to the mark log information from a web server via the communication unit 110, downloads the content, and links the content with the mark log information. Mark log information refers to information that is selectively and/or randomly marked on the content by one or more users, a manufacturer, or a content producer, or any other suitable person or entity. The mark log information may also be additionally defined by a user or a manufacturer.

Also, in an on-line state, the control unit 160 searches and downloads content based on mark log information in real-time. In an off-line state, the control unit 160 stores mark log information in the storing unit 130 to use later in an on-line state.

The image processing unit 140 converts image data output from the control unit 160 into R (red), G (green), and B (blue) video data signals, or any other video image data format and/or signal that may be received and displayed by the display unit 170.

The sound processing unit 150 converts sound data output from the control unit 160 from digital sound data into analog audio signals for output by the speaker 180.

The display unit 170 displays the content output from the image processing unit 140 in text form, or any other suitable format (e.g., a video format, an audio format, an audio-visual format, etc.).

The speaker 180 reproduces the analog audio signals output from the sound processing unit 150 into sound.

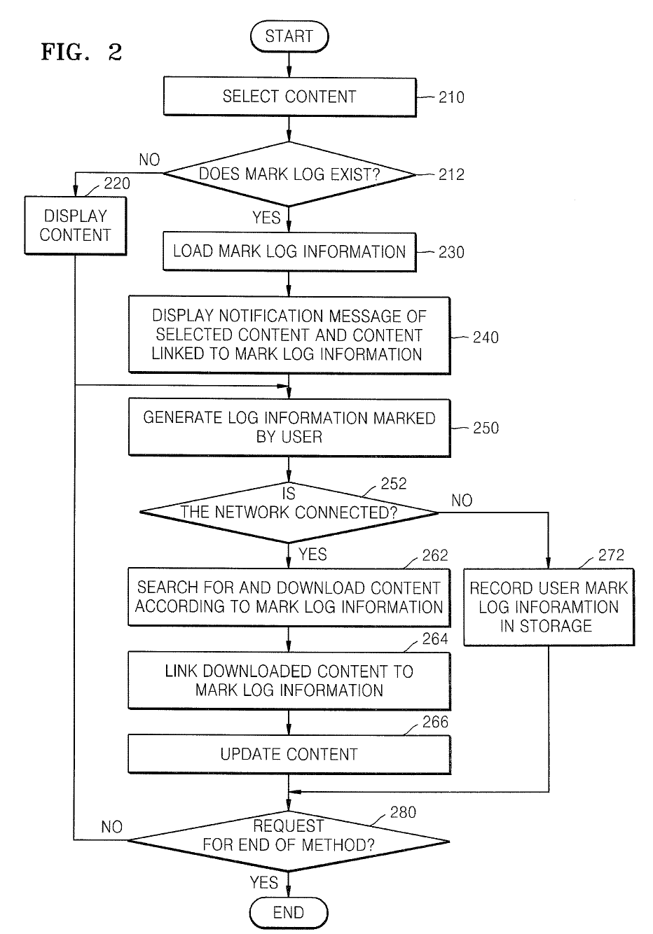

FIG. 2 illustrates a flowchart of a method of providing user-customized content to an apparatus having a text viewer, according to an embodiment of the present general inventive concept.

In operation 210, text-based content the user desires are selected from among the content displayed on a screen of the apparatus (e.g., display unit 170 of apparatus 100 of FIG. 1).

It is determined whether previously recorded mark log information by the user exists in operation 212. Mark log information refers to recording information that is randomly marked on the content by the user or a manufacturer. The mark log information may also be additionally defined by a user or a manufacturer.

If it is determined that the mark log information exists in operation 212, corresponding mark log information is loaded in operation 230. Otherwise, if it is determined that the mark log information does not exist in operation 212, text-based content are displayed in operation 220.

When the mark log information is loaded, a notification message that notifies a user that selected content and content linked to the mark log information exist is displayed in operation 240. When the user selects the content, the user-customized content providing apparatus 100 illustrated in FIG. 1 provides documents such as video files of lessons, item pools, dictionaries, additional explanation, and other information that are linked to the corresponding content.

In operation 250, mark logs are generated for the portions of the content marked by the user. The mark logs are classified into link information according to classification definitions received from the user or by using preset classification definitions for link information.

In operation 252, it is determined when the user-customized content providing apparatus (e.g., user-customized content providing apparatus 100) is connected to the network or not by checking the connection of the apparatus to the network.

If it is determined that the apparatus is connected to the network in operation 252, corresponding content is automatically searched for in the web server using the generated mark logs, and the found content is downloaded from the web server in operation 262.

In operation 264, the content downloaded from the web server is linked to the corresponding mark log information.

In operation 266, the downloaded content is added to the main text content to update the main text content. The main text content may include content other than text, such as video, audio, or other audio-visual content.

Alternatively, the found content from the web server can be displayed on the screen using icons or any other suitable graphic and/or text-based indicator. Accordingly, if it takes a longer than a predetermined amount of time to search for and link, the found content can be provided to the user using icons. Also, the linked content can be provided as a summary after a predetermined view section is completed.

Otherwise, if it is determined that the apparatus (e.g., user-customized content providing apparatus 100 of FIG. 1) is not connected to the network, mark log information by the user is recorded in a separate storage so that the mark log information can be used to automatically search, download, and link content once converted to an on-line state in operation 272. The separate storage may be a separate portion of storing unit 130, or may be a separate storing unit communicatively coupled to user-customized content providing apparatus 100 of FIG. 1, or may be communicatively coupled to user-customized content providing apparatus 100 via the network.

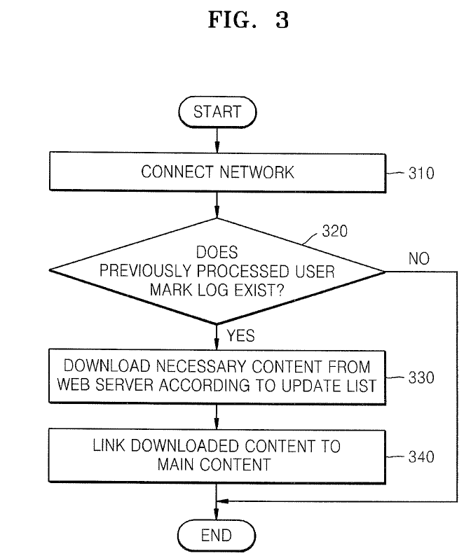

FIG. 3 illustrates a flowchart of a method of providing user-customized content in an apparatus (e.g., user-customized content providing apparatus 100 of FIG. 1) when the off-line state is converted into an on-line state.

In operation 310, when the apparatus is connected to the network by the user, the off-line state is converted into the on-line state.

In operation 320, in the on-line state, it is determined whether previously-processed user mark log information related to updating exists.

If it is determined that the user mark log information processed beforehand and related to updating exists in operation 320, content is downloaded via the web server according to the update list recorded in the mark log information in operation 330.

In operation 340, corresponding content downloaded from the web server is linked to the main text content.

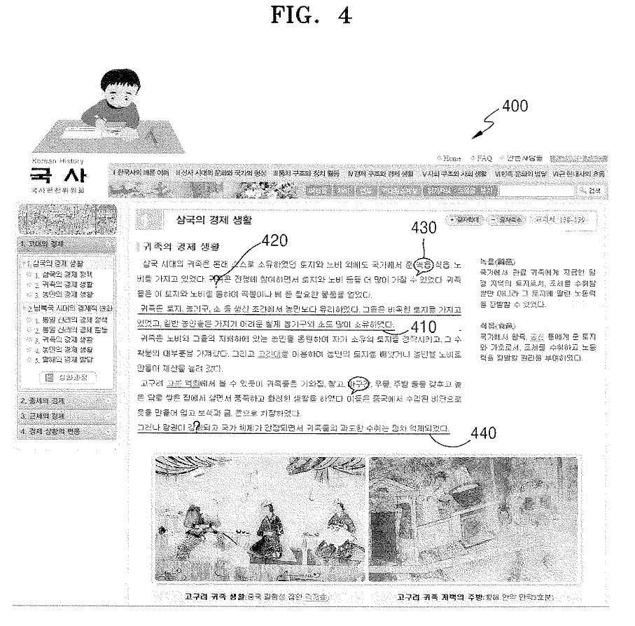

FIG. 4 illustrates mark log information generated from a user's selections of information according to an embodiment of the present general inventive concept.

For example, in the case of an e-book as illustrated in FIG. 4, mark log information 410, 420, 430, and 440, marked in various forms, are marked information in the text-based content of display 400. For example, the mark log information 410 may refer to information deemed important by a user and was accordingly selected. The mark log information 420 may refer to questions identified by a user. The mark log information 430 may relate to additional explanation information. Also, the mark log information 440 may related to general explanation information.

The mark log information 410, 420, 430, and 440 is generated on at least portions of the content desired by the user (e.g., by selection of the content by the user). Thus, the content portions of the mark log information 410, 420, 430, and 440, marked in one or more forms, are linked to related documents provided from the web server.

Also, the mark log information 410, 420, 430, and 440 are classified into link information according to the definition received from a user, or a manufacturer, or any other suitable person or entity.

For example, the important mark log information 410 may link to related content to the important content identified by the user. Also, the mark log information 420 may link to a video file of lessons related to the content of the questions identified by the user. The mark log information 430 may link to additional explanation information related to the content identified by the user. Also, the explanation mark log information 440 may link to video files of lessons that provide general information related to the selected content.

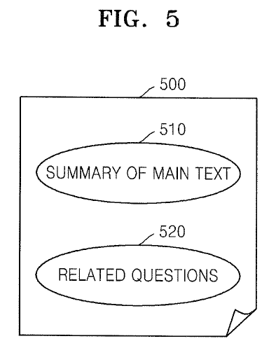

FIG. 5 illustrates a conceptual diagram of providing content corresponding to user mark log information according to an embodiment of the present general inventive concept.

For example, in the case of an e-book, an item pool about the corresponding content can be formed according to the user mark log information. For example, explanations about examination questions are recorded as the user mark log information. In addition, according to the user mark log information, additional questions can be linked to, or questions answered incorrectly can be provided as study-aid material summarizing incorrect answers. Additionally, based on the incorrectly answered questions, additional questions or related study-aid material may be provided to supplement the user's instruction regarding the concepts tested.

Referring to FIG. 5, a summary of the main text 510 and questions related thereto (e.g., related questions 520) can be provided in display 500 according to the mark logs marked as important by the user.

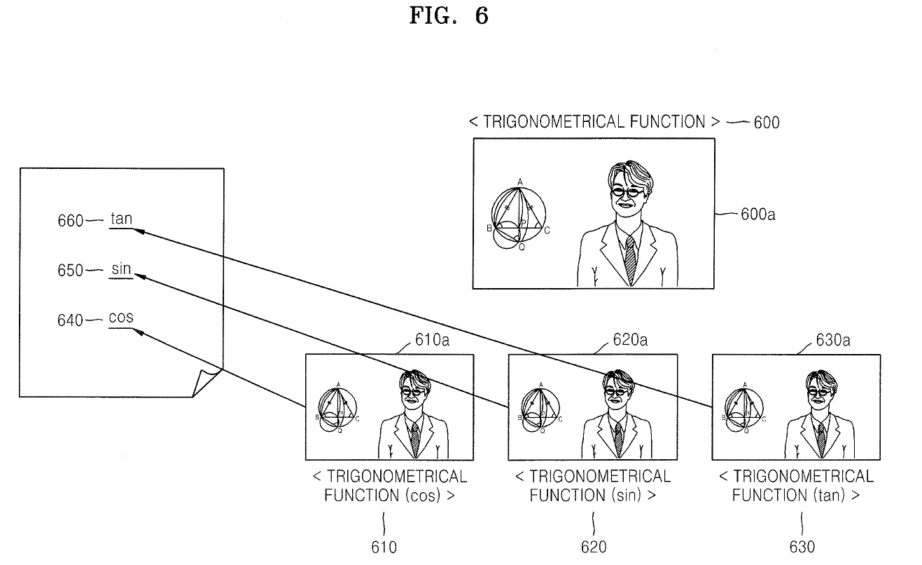

FIG. 6 illustrates a conceptual diagram of separating content and linking the content to mark log information.

For example, video files of lessons typically require a long time to be reproduced and a large amount of storage space.

As illustrated in FIG. 6, when there is tag information in the video files of lessons (e.g., tag information 600, 610, 620, and 630), one video file of lessons (e.g. video file 600a) can be divided into pieces (e.g., video files 610a, 620a, and 630a) to be connected to the mark log information (e.g., mark log information for trigonometrical function 640, trigonometrical 650, and trigonometrical function 660). For example, mark logs of trigonometrical function 640 (cos), trigonometrical function 650 (sin), and trigonometrical function 660 (tan) are respectively linked to the video file 610a of a lesson on a trigonometrical function (cos), the video file 620a on a lesson on a trigonometrical function (sin), and the video trigonometrical function (tan) according to the tag information in the video file of lessons.

Accordingly, at least a piece of the video file of lessons (e.g., video files 610a, 620a, and 630a) is linked to the mark log (e.g., mark log information for trigonometrical function 640, trigonometrical 650, and trigonometrical function 660) to prevent time from being wasted due to watching unnecessary parts and to efficiently control the storage space.

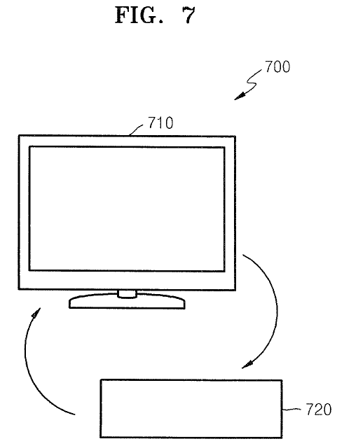

FIG. 7 illustrates a content providing apparatus 700 linking to text-based meta information of the content input by the user according to another embodiment of the present general inventive concept.

The content providing apparatus 700 of FIG. 7 includes a TV 710 and an information terminal 720.

The TV 710 transmits and/or receives content to and/or from a web server in a wired and/or wireless manner, displays text information on a display screen of the information terminal 720, and searches for and downloads corresponding content from the web server using the mark log information input through the information terminal 720.

The information terminal 720 may, for example, function as a remote control and transmits and/or receives content to and/or from the TV 710 in a wired and/or wireless manner, displays text information input by the TV 710 on a display screen of the information terminal 720, and transfers the mark log information generated on the text information to the TV 710.

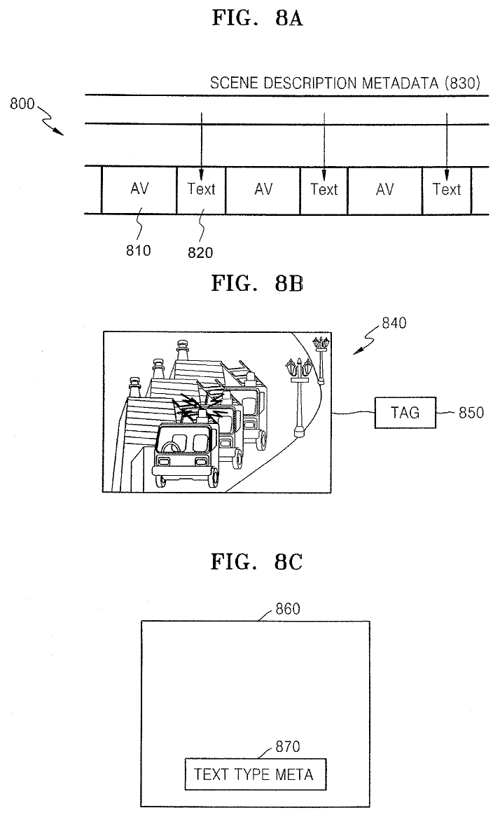

FIGS. 8A through 8C illustrate text-based meta information applied in the content providing apparatus 700 of FIG. 7.

FIG. 8A illustrates a signal format 800 of a broadcasting stream including text information 810 that is added to A/V data 820 and scene description metadata 830.

FIG. 8B illustrates a video 840 including tag information 850 for each scene, that is, moving images include tag information for each scene of video 840.

FIG. 8C illustrates a file format 860 including text-type metadata 870.

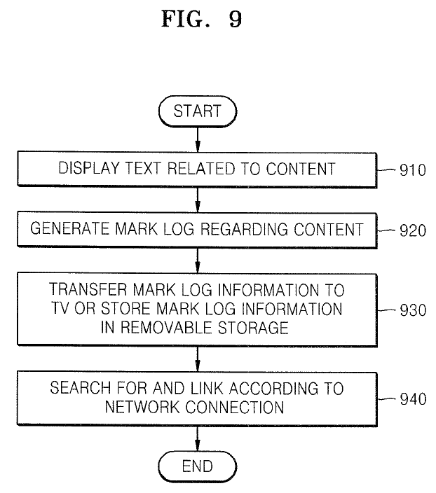

FIG. 9 is a flowchart illustrating a method of providing user-customized content realized in the content providing apparatus 700 of FIG. 7, according to an embodiment of the present general inventive concept.

In operation 910, when the user inputs a predetermined command related to content search, text related to the current content is displayed on the TV 710 or the information terminal 720.

By viewing the text on the information terminal 720, the user selects information based on content the user needs.

Accordingly, in operation 920, the information terminal 720 generates mark logs based on the selected content by the user.

In operation 930, the information terminal 720 transfers the generated mark log information to the TV 710 or records the generated mark log information on a removable storage or any other suitable digital storage device.

In operation 940, the TV 710 and the information terminal 720 perform search and link operations according to the network connection (e.g., on-line state, off-line state, etc.).

For example, in an on-line state, the TV 710 may search for and download content in real-time according to the mark log information, and if the content is to be recorded in a personal video recorder (PVR) or other digital storage device, the TV 710 may link the found content to the recorded content in the PVR. Also, in an off-line state, a removable storage in which mark logs are stored is connected to the information terminal 720, the information terminal 720 automatically searches for content according to the mark log information and stores the content in the removable storage.

Accordingly, when mark logs are recorded in the removable storage, and the removable storage is connected to the information terminal 720, the information terminal 720 can immediately display the found content on the screen.

The present general inventive concept general inventive concept can also be embodied as computer readable codes on a computer readable medium. The computer-readable medium can include a computer-readable recording medium and a computer-readable transmission medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. The computer-readable transmission medium can transmit carrier waves and signals (e.g., wired or wireless data transmission through the Internet). Also, functional programs, codes, and code segments to accomplish the present general inventive concept can be easily construed by programmers skilled in the art to which the present general inventive concept pertains.

As described above, according to the present general inventive concept, the user can automatically search for the content the user has marked and link the content to corresponding documents without having to directly search through large amounts of documents. Also, using mark logs, the user can create a study-aid book comprising video files of lessons, images, related documents, item pools, or other related information that is customized for each user. Also, the method of providing content according to the present general inventive concept can be used on-line or off-line. In addition, the user can efficiently use limited resources by arranging necessary content first.

While the present general inventive concept has been particularly illustrated and described with reference to exemplary embodiments thereof, it will be understood by one of ordinary skill in the art that various changes in form and details may be made therein without departing from the spirit and scope of the present general inventive concept as defined by the following claims.

What is claimed is:

1. A method of providing digital content, comprising:
displaying selected content;
generating mark log information according to marking of the displayed content; and
searching for content related to the generated mark log information on a server and linking the content found via the searching to the mark log information.

2. The method of claim 1, wherein the mark log information is randomly or selectively marked recording information by a user.

3. The method of claim 1, wherein the mark log information is defined by a user or a manufacturer.

4. The method of claim 1, wherein the mark log information is additionally defined by a user or a manufacturer.

5. The method of claim 1, further comprising:
classifying the mark log information into one or more link information classifications defined by a user or a manufacturer.

6. The method of claim 1, wherein in the generating of the mark log information, if an off-line state is determined, further comprising:
storing the mark log information in a separate storage.

7. The method of claim 6, further comprising:
determining when an off-line state is converted into an on-line state;
downloading corresponding content from a web server; and
linking to the mark log information by using the mark log information recorded in the storage.

8. The method of claim 1, further comprising:
displaying result information of the content found from the web server on a display screen using icons.

9. The method of claim 1, further comprising:
if tag information is included in the downloaded content found from the web server, separating the content according to tag information and linking corresponding mark log information to each of the separated content.

10. A method of providing user-customized digital content, the method comprising:
selecting content;
determining whether mark log information in a predetermined format exists;
if it is determined that mark log information in the predetermined format exists, loading the mark log information;
displaying a notification message notifying a user of the selected content and content linked to the loaded mark log information;
generating mark log information regarding the displayed content according to markings in a predetermined format; and
searching content according to the mark log information and downloading the content.

11. The method of claim 10, further comprising:
when an apparatus is not connected to the network, storing the generated mark log information in a separate storage.

12. The method of claim 10, further comprising:
displaying search result information of the content on a display screen using icons.

13. The method of claim 10, further comprising:
storing the generated mark log information in a removable storage.

14. An apparatus of providing content, comprising:
a storing unit to store content and mark log information of a user;
a display unit to display text-based content; and
a control unit to generate mark log information according to user marking of the content displayed in the display unit and to store the mark log information to the storing unit, and to search for content related to the mark log information in a web server and, once the content are found in the web server, the control unit to download the content from the web server to link the content to the mark log information.

15. A computer readable medium having a computer readable program for executing a method of providing digital content, the method comprising:
displaying selected content;
generating mark log information of a user according to marking of the displayed content; and
searching for content related to the generated mark log information on a server and linking the content to the mark log information.

16. A method of providing user-customized digital content, the method comprising:
receiving a command to search for digitally stored content;
display content retrieved from the search;
receiving one or more marks to select content for the displayed content;
generating a mark log from the received one or more marks to select content; and
searching content on a storage device or remote server based at least in part on the generated mark log.

17. The method of claim 16, further comprising:
providing content retrieved from the search based at least in part on the generated mark log.

18. The method of claim 17, wherein the provided content is audio content, video content, audio-visual content, or text, or any combination thereof.

19. The method of claim 16, further comprising:
classifying the received one or more marks based at least in part on one or more predetermined classifications, or user-defined classifications, or any combination thereof.

20. The method of claim 19, further comprising:
providing content retrieved from the search based at least in part on the classified one or more marks.
